(19) United States
(12) Patent Application Publication
(10) Pub. No.: US 2015/0213403 A1
(43) Pub. Date: Jul. 30, 2015

(54) SYSTEM OF SECURELY DELIVERING PACKAGES

(71) Applicants: Wayne Dorpfeld, Albion, NY (US); Steven Ferrarese, Rochester, NY (US)

(72) Inventors: Wayne Dorpfeld, Albion, NY (US); Steven Ferrarese, Rochester, NY (US)

(21) Appl. No.: 14/606,449

(22) Filed: Jan. 27, 2015

Related U.S. Application Data
(60) Provisional application No. 61/932,050, filed on Jan. 27, 2014.

(51) Int. Cl. G06Q 10/08

(52) U.S. Cl. CPC G06Q 10/0836; G06Q 10/0833

(57) ABSTRACT

A method of delivering a package comprising the steps of receiving an order for an item to be delivered to a recipient, producing and sending a unique shipment tracker code to the recipient, producing and sending a unique courier code to the recipient, delivering the item to the recipient's address, whereby a lock box is unlocked using the unique courier code, and, notifying the recipient that the item has been delivered to the lock box.

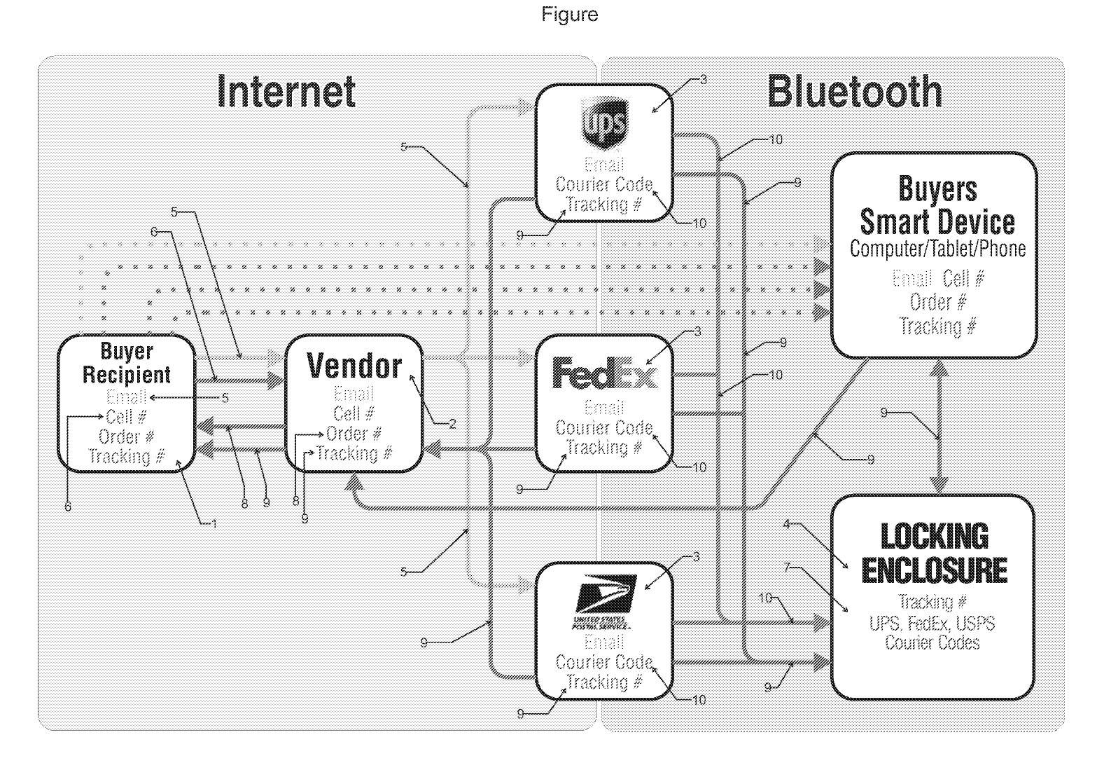

### CROSS-REFERENCE TO RELATED APPLICATIONS

This application claims the benefit under 35 U.S.C. §119(e) of U.S. Provisional Patent Application No. 61/932,050, filed Jan. 27, 2014, which application is incorporated herein by reference in its entirety.

### FIELD OF THE INVENTION

The present invention relates to a system of securely delivering packages.

### BACKGROUND OF THE INVENTION

With the increase in internet sales, and home and business deliveries of merchandise by courier services there exists significant incidences of theft following their deliveries when no one is available to receive the merchandise

As can be seen, there is a need for a system for securely delivering packages.

### BRIEF DESCRIPTION OF THE DRAWINGS

The FIGURE is a schematic view of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method of delivering a package comprising: receiving an order for an item to be delivered to a recipient; producing and sending a unique shipment tracker code to the recipient; delivering the item to the recipient's address, whereby a lock box is unlocked using a unique courier code and downloading the unique shipment tracker code to the box; the recipient uses the previously receive shipment tracker code to unlock the box and take possession of the shipment. The recipient notifies the sender via internet or cellular that the item has been delivered to the lock box and received.

The present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the interact, extranet, intranet, host server, internet cloud and the like.

The present invention includes a system designed to protect package and document deliveries from theft and unauthorized access. The present invention allows the courier service to place the delivery in a securely locked container, only accessible by the intended recipient. Currently no such system utilizing a lockable secure enclosure is available and accessible only by the courier services and the intended recipient of the delivery. Currently deliveries are left unattended at their destination, exposed to potential theft, or the courier may require the recipient to come to their shipping terminal to pick up and sign for the delivery. The present invention provides for a secure and documented confirmation of delivery at the recipients home or business.

Referring now to the Figure, the recipient or buyer (1) of the item to be received places an order or request for the item with the sender or vendor (2). Upon receiving the order or request the sender or vendor (2) transmits an order number (8) via text or email to the recipient or buyer (1). The sender or vendor (2) of the item to be delivered selects a courier (3). When the courier (3) receives the request for delivery service the courier (3) assigns and transmits a unique shipment tracker code (9) to the sender or vendor (2). The sender or vendor (2.) forwards the unique shipment tracker code (9) to the recipient or buyer (1). The courier takes possession of the packaged item ordered from the sender or vendor (2) and delivers it to the recipient or buyer's physical address (7) specified on the order. When the courier (3) delivers the shipment to the recipient (1), the courier (3) transmits their unique courier code (10), wirelessly, such as via Bluetooth communication, using their smart device to the recipient's weather resistant, locking enclosure (4). Upon receiving the courier code (10) the enclosure (4) unlocks allowing the courier (3) to place the delivery in the enclosure (4). At the same time the courier code (10) is transmitted to unlock the enclosure (4), the unique shipment tracker code (9) is downloaded from the courier's smart device to the recipient's enclosure (4) lock mechanism and stored. The recipient or buyer (1) is notified via email or text message that the delivery has been received. Upon receipt of the message the recipient or buyer (1) goes to the package enclosure (4) and transmits the shipment tracker code (9) from their smart device to the enclosures lock mechanism via wireless communication, unlocking and allowing access to the enclosure (4) and the shipment. The recipient or buyer's smart device sends a text message to the sender or vendor (2) informing them the shipment has been received. The locking enclosure may be permanently secured to an immovable structure, such as but not limited to a building, house, porch, deck, patio, wall, etc. by fasteners accessible from the inside of the secure enclosure (4), thereby requiring the ability to unlock the enclosure (4) to gain access to the fasteners.

Using current business practices, the buyer's merchandise is tracked via email and text communication between the vendor, the courier service and the recipient. The merchandise shipped from the vendor remains secure from theft throughout the delivery process until it is delivered to recipient's unsecured delivery location. At this point in the process the merchandise is often exposed to the environment and potential theft. The use of a secure enclosure of the present invention, only accessible by the courier service and the recipient, ensures secure delivery of the merchandise and allows for confirmation of its receipt by the intended recipient.

A method of making the present invention may include the following: create for the courier a smart device application capable of receiving, storing and transmitting via wireless transmission such as Bluetooth and/or Internet a courier code number and shipment tracking code number to a devise capable of receiving the numbers; provide a secure locking container with an electronic lock mechanism capable of storing and receiving a courier code number and a shipment tracking code number via wireless communication, which will unlock the secure locking container; cause the lock mechanism to confirm to the courier's smart devise that the shipment tracking code has been received and stored; cause the lock mechanism to confirm to the recipient's smart devise that the tracking code has been received and the container has been unlocked; incorporate into the recipients smart device application the ability to transmit via internet or cellular to the vendor an acknowledgement that the shipment tracking code has been sent to the secure locking container, and that the container has been unlocked. Provide that locking container may be securely fastened to an unmovable object.

A method of using the present invention may include the following. Buyer/Recipient of Order—Place order with vendor and receive order confirmation via text and email to smart device. Receive Name of Courier and shipment tracking code number via text and email to smart device. Vendor—Receive order. Select Courier. Receive shipment tracking code number from Courier and forward to Buyer. Courier—Pickup shipment from vendor. Deliver shipment to Buyer's physical address and Secure Locking Enclosure. Unlock Enclosure by transmitting Courier Code via Bluetooth and downloading Shipment Tracking Code to Lock Mechanism of the Secure Enclosure from the Courier's Smart Device. Place shipment in Secure Enclosure and close, automatically locking enclosure. Buyer/Recipient of Order—Transmit previously received Shipment Tracking Code stored in smart device to the Secure Locking Enclosure causing it to unlock. The lock mechanism confirms to the recipient's smart devise that it has received the code and unlocked. The smart devise communicates to the Vendor that Enclosure has been unlocked and the shipment has been received.

In alternative embodiments, it is not required that the recipients smart devise confirm to the vendor that the shipment tracking code number has been transmitted to the secure locking container and that the container has been unlocked. The owner of the Secure Locking Enclosure may use it to securely transfer goods from themselves to another party by programming in another unique number allowing the Enclosure to be unlocked and communicating that number to the intended recipient via text, email, voice etc. so the recipient can gain access.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. in addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method of delivering a package comprising:
receiving an order for an item to be delivered to a recipient;
producing and sending a unique shipment tracker code to the recipient;
producing and sending a unique courier code to the recipient;
delivering the item to the recipient's address, whereby a lock box is unlocked using the unique courier code; and,
notifying the recipient that the item has been delivered to the lock box.

2. A method of delivering a package comprising:
receiving an order for an item to be delivered to a recipient;
producing, storing and sending a unique shipment tracker code to the recipient;
producing and sending a unique courier code allowing the courier to unlock the secure container;
delivering the item to the recipient's address, whereby a lock box is unlocked using the unique courier code; and,
notifying the recipient that the item has been delivered to the lock box.
